(19) United States
(12) Patent Application Publication
(10) Pub. No.: US 2005/0177399 A1
(43) Pub. Date: Aug. 11, 2005

(54) System and method for generating documentation from flow chart navigation

(76) Inventor: Ben Harris Park, Zionsville, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 11/052,587

(22) Filed: Feb. 7, 2005

Related U.S. Application Data
(60) Provisional application No. 60/542,067, filed on Feb. 5, 2004.

(51) Int. Cl. G06F 17/60

(52) U.S. Cl. 705/3

(57) ABSTRACT

A computer system and method is disclosed that aids a user in automatically generating patient documentation. Users, such as physicians, can access the system over a network. Upon a user navigating a flow chart to diagnose and/or manage a patient's condition, textual or other documentation of the path taken through the flow chart is automatically generated. Actions in the same or other systems can also be performed automatically based on the path taken through the flow chart, such as launching a scheduling system for scheduling a patient follow-up visit, automatically placing an order for a test, automatically scheduling a task on to a medical worker's task list, automatically generating a referral letter, or automatically generating patient educational material from a template, as a few examples. If an action on the flow chart requires additional information, a separate window can be opened to allow the user to enter the additional information.

### CROSS REFERENCE TO RELATED APPLICATIONS

This application claims the benefit of U.S. Provisional Application No. 60/542,067 filed Feb. 5, 2004, which application is incorporated herein in its entirety.

### BACKGROUND OF THE INVENTION

The present invention relates to computer systems, and more particularly, but not exclusively, relates to systems for generating documentation.

Physicians currently spend a significant amount of effort dictating, typing, or writing patient notes to document the diagnosis or treatment of a patient's condition at the end of the patient's visit or thereafter. Some systems have attempted to solve this problem by providing a list of pre-determined text that the physician can select on an individual basis to include in the patient record after the physician has completed the diagnosis or treatment. These systems still require the physician to take the time to manually document the patient record by selecting the one or more appropriate textual descriptions that accurately describe the patient's treatment for inclusion in the patient treatment history. Further advancements are needed to automate the documentation process. The current invention is directed to meeting this and other needs.

### SUMMARY OF THE INVENTION

One form of the present invention is a computer system. Other forms include unique systems and methods to generate documentation.

In one aspect of the invention, a computer system and method is disclosed that aids in automatically generating patient documentation. Users, such as physicians, can access the system over a network. Upon a user navigating a flow chart to diagnose and/or manage a patient's condition, textual or other documentation of the path taken through the flow chart is automatically generated. Actions in the same or other systems can also be performed automatically based on the path taken through the flow chart, such as launching a scheduling system for scheduling a patient follow-up visit, automatically placing an order for a test, automatically scheduling a task on to a medical worker's task list, automatically generating a referral letter, or automatically generating patient educational material from a template, as a few examples. If an action on the flow chart requires additional information, a separate window can be opened to allow the user to enter the additional information.

Further forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one embodiment of the present invention.

FIG. 2 is a process flow diagram for the system of FIG. 1 demonstrating the high level stages involved in using the system to automatically generate patient documentation.

FIG. 3A is a first part of a process flow diagram for the system of FIG. 1 demonstrating the stages involved in automatically generating patient documentation upon selecting a particular option.

FIG. 3B is a second part of a process flow diagram for the system of FIG. 1 demonstrating the stages involved in automatically generating patient documentation upon selecting a particular option.

FIG. 4 is a simulated screen for the system of FIG. 1 and process of FIG. 2 illustrating a patient record that allows creation and/or viewing of patient treatment documentation.

FIG. 5 is a simulated screen for the system of FIG. 1 and process of FIG. 2 and FIGS. 3A-3B illustrating a flow chart used for diagnosing and/or managing a patient's treatment and for automatically generating patient treatment documentation.

FIG. 6 is a simulated screen for the system of FIG. 1 and process of FIG. 2 and FIGS. 3A-3B illustrating sample patient treatment documentation that was generated based upon navigation through the flow chart of FIG. 5.

FIG. 7 is a simulated screen for the system of FIG. 1 and process of FIG. 2 and FIGS. 3A-3B illustrating the previous path that has been taken through the flow chart.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

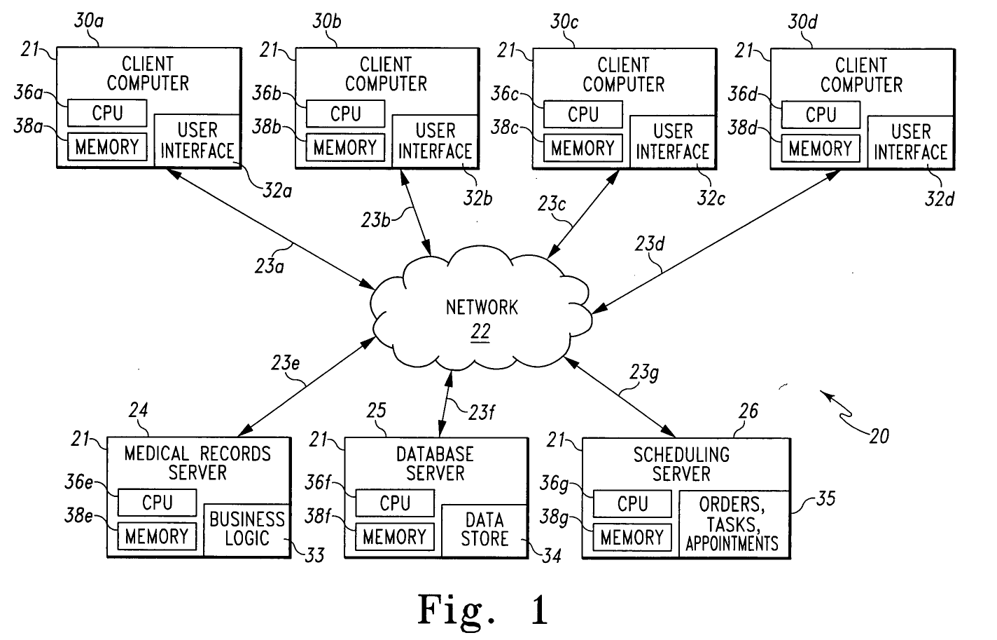

FIG. 1 is a diagrammatic view of computer system 20 of one embodiment of the present invention. Computer system 20 includes computer network 22. Computer network 22 couples together a number of computers 21 over network pathways 23a-g. System 20 includes multiple servers, namely Medical Records Server 24, Database Server 25, and Scheduling Server 26. System 20 also includes client computers 30a, 30b, 30c, and 30d (collectively 30). While computers 21 are each illustrated as being a server or client, it should be understood that any of computers 21 may be arranged to include both a client and server. Furthermore, it should be understood that while seven computers 21 are illustrated, more or fewer may be utilized in alternative embodiments.

Computers 21 include one or more processors or CPUs (36a, 36b, 36c, 36d, 36e, 36f, and 36g, respectively) and one or more types of memory (38a, 38b, 38c, 38d, 38e, 38f, and 38g, respectively). Although not shown to preserve clarity, each memory 38a, 38b, 38c, 38d, 38e, 38f, and 38g includes a removable memory device. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory (removable or generic) is one form of computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown to preserve clarity, in one embodiment each computer 21 is coupled to a display. Computers may be of the same type, or a heterogeneous combination of different computing devices. Likewise, displays may be of the same type, or a heterogeneous combination of different visual devices. Although again not shown to preserve clarity, each computer 21 may also include one or more operator input devices such as a keyboard, mouse, track ball, light pen, and/or microtelecommunicator, to name just a few representative examples. Computer 21 may be a desktop computer, laptop computer, tablet pc, personal digital assistant (PDA), or another digital computer device as is known in the art. Also, besides display, one or more other output devices may be included such as loudspeaker(s) and/or a printer. Various display and input device arrangements are possible.

Computer network 22 can be in the form of a wired and/or wireless Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 can be coupled together by computer network 22.

In one embodiment, system 20 operates at one or more physical locations to provide a system for automatically generating patient documentation and related activities. In the context of system 20, documentation is referring to printed and/or electronic information. In one embodiment, Medical Records Server 24 is configured to host business logic 33 for managing patient medical records, and generating patient documentation and related activities. In one embodiment, client computers 30a-30d are configured for providing a user interface 32a-32d, respectively, that accesses business logic 33 of medical records system 20 on Medical Records Server 24. One of ordinary skill in the software art will appreciate that user interface 32a-32d and business logic 33 can be hosted on one or more computers in a thin client or thick client architecture and still be within the spirit of the invention. As a few non-limiting examples, system 20 can be implemented as a browser-based application with user interface 32a-32d residing on a client computer and business logic 33 residing on a web server, as an n-tier application with the various components distributed across three or more computers, as a standalone application with the entire system 20 residing on a single computer, and/or as a client-server application. Other variations are also possible as would occur to one of ordinary skill in the programming art. In one embodiment, Database Server 25 is operable to store patient record data in data store 34. In one embodiment, Scheduling Server 26 is operable to manage orders, tasks, and appointments related to patient treatment activities.

Typical applications of system 20 would include more or fewer client computers of this type at one or more physical locations, such as office and examination rooms, but four have been illustrated in FIG. 1 to preserve clarity. Furthermore, although three servers are shown, it will be appreciated by those of ordinary skill in the art that the one or more features provided by Medical Records Server 24, Database Server 25, and Scheduling Server 26 could be provided on the same computer or varying other arrangements of computers at one or more physical locations and still be within the spirit of the invention. Farms of dedicated servers could also be provided to support the specific features if desired.

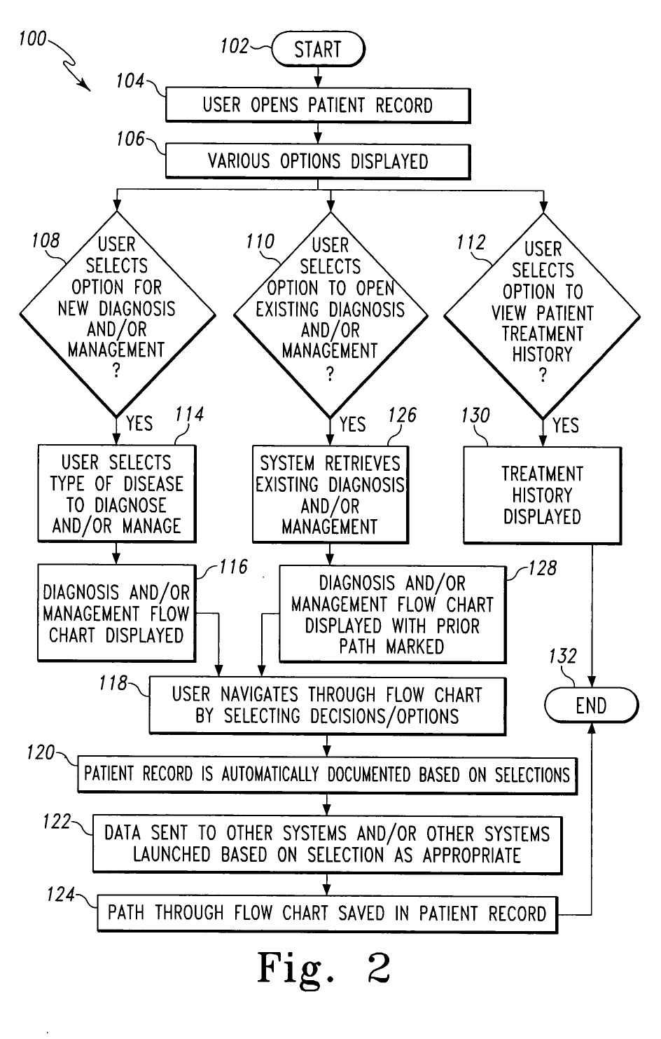

Referring additionally to FIG. 2, one embodiment for implementation with system 20 is illustrated in flow chart form as procedure 100, which demonstrates the high level stages involved in using system 20 to automatically generate patient documentation. In one form, procedure 100 is at least partially implemented in the operating logic of system 20. Procedure 100 begins at start point 102 with the user opening a particular patient record (stage 104). Various patient details are displayed, including the patient's name, date of birth, social security number, address, and so on. From the patient record, the user is also presented with various options (stage 106), including starting a new diagnosis and/or management session (decision point 108), opening an existing diagnosis and/or management session (decision point 110), or viewing the patient treatment history (decision point 112). One or more levels of security can be implemented in system 20 to allow only authorized users to view certain records and/or take certain actions.

If the user selects the option to start a new diagnosis and/or management session (decision point 108), the user is presented with a list of diseases or symptoms to diagnose and/or manage. The diseases or symptoms can be presented in various categories, such as acute versus chronic, to name a few non-limiting examples. The user selects a particular type of disease to diagnose and/or manage (stage 114) from the list. In one embodiment, the options for diagnosing a disease are listed separately from the options for managing a disease that has already been diagnosed. Alternatively or additionally, the options for managing a disease can be included as part of the options for diagnosing the particular disease. Upon selecting the type of disease to diagnose and/or manage (stage 114), a corresponding diagnosis and/or management flow chart is displayed (stage 116). The flow chart provides the user, such as a physician, with a visual set of stages to walk through in diagnosing or treating the patient. In an alternate embodiment, a series of screens that guide the user through the steps one decision at a time are used instead of a visual flow chart. The user navigates through the flow chart by selecting one or more decisions/options displayed on the flow chart (stage 118). The patient record is automatically documented based on the selections made by the user (stage 120). Data can also be sent to other systems and/or other systems can be launched based on the selection, when appropriate (stage 122). The path taken by the user through the flow chart is saved in the patient record (stage 124) on data store 34 of Database Server 25.

If the user selects the option to open an existing diagnosis and/or management session (decision point 110), the flow chart for the selected prior diagnosis and/or management session is retrieved (stage 126) and displayed on the screen with the prior path visually indicated (stage 128). The flow chart provides the user, such as a physician, with a visual set of stages to walk through in diagnosing or treating the patient. In an alternate embodiment, a series of screens that guide the user through the steps one decision at a time are used instead of a visual flow chart. The user resumes navigation through the flow chart by selecting one or more decisions/options displayed on the flow chart (stage 118). The patient record is automatically documented based on the selections made by the user (stage 120). Data can also be sent to other systems and/or other systems can be launched based on the selection, when appropriate (stage 122). The path taken by the user through the flow chart is saved in the patient record (stage 124) on data store 34 of Database Server 25. Alternatively or additionally, a user can be prompted to confirm selection of an option before the associated action is taken, and/or can have the ability to undo an action that was launched accidentally.

If the user selects the option to view the patient treatment history (decision point 112), the treatment history is displayed (stage 130) on the screen to the user. The treatment history includes the documentation that was generated automatically based upon the user's navigation through the flow chart, as well as any additional documentation that the user may have entered manually, if any. Procedure 100 then ends at end point 132.

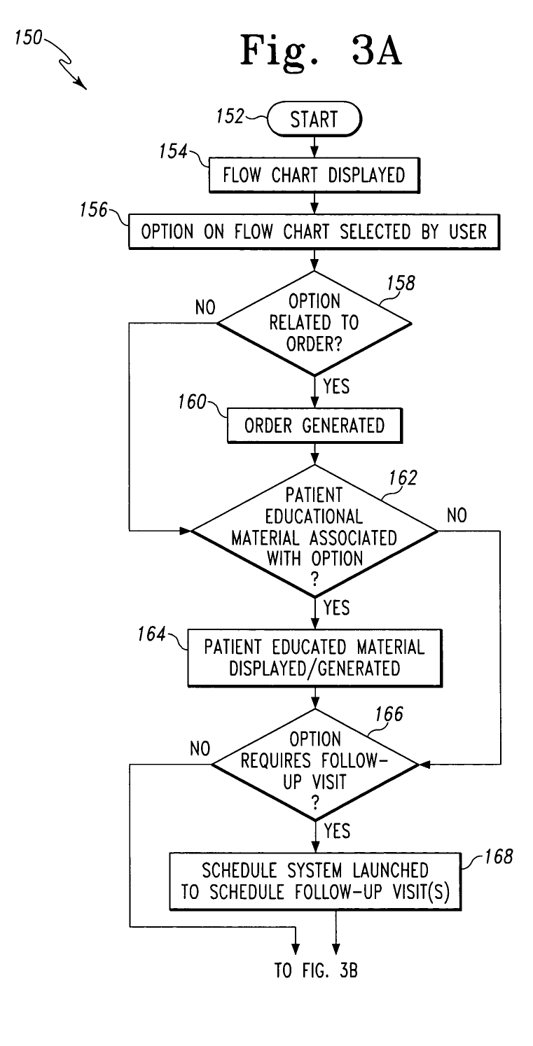

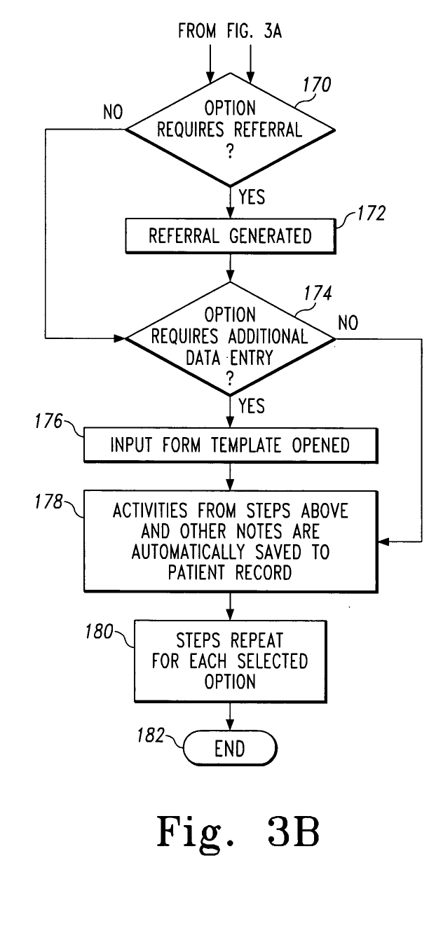

Referring additionally to FIGS. 3A-3B, procedure 150 demonstrates the stages involved in generating patient documentation and related actions upon selecting a particular option. In one form, procedure 150 is at least partially implemented in the operating logic of system 20. Procedure 150 begins on FIG. 3A at start point 152 with the diagnosis and/or management flow chart being displayed (stage 154). When the user, such as a physician, selects an option on the flow chart (stage 156), various actions can automatically be taken based on the type of action that was selected. For example, if the selected option requires that an order, such as for a lab, be placed (decision point 158), then an order can be generated automatically (stage 160). If the selected option has patient educational material associated with the option (decision point 162), then patient educational material can be generated and/or displayed (stage 164). If the selected option requires that the user return for a follow-up visit (decision point 166), then a scheduling process, such as on Scheduling Server 26, can be launched so the follow-up visit can be scheduled (stage 168).

Continuing with FIG. 3B, if the selected option on the flow chart requires a referral to another physician or medical facility (decision point 170), then a referral document, such as a referral letter, is automatically generated (stage 172). If the selected option requires additional data entry (decision point 174), then an input form is displayed where the user can add additional data (stage 176). Additional automated activities are also possible, such as automatically printing a patient prescription that can be signed by the physician, or electronically transmitting the prescription information to a pharmacy, to name a few non-limiting examples. Details about these prior activities, if applicable, are saved automatically to the patient record, along with a pre-determined description that corresponds to the diagnosis and/or management decision or path taken by the user through navigating the flow chart (stage 178). Stages 156-178 are repeated for each option on the flow chart selected by the user (stage 180). Procedure 150 then ends at end point 182.

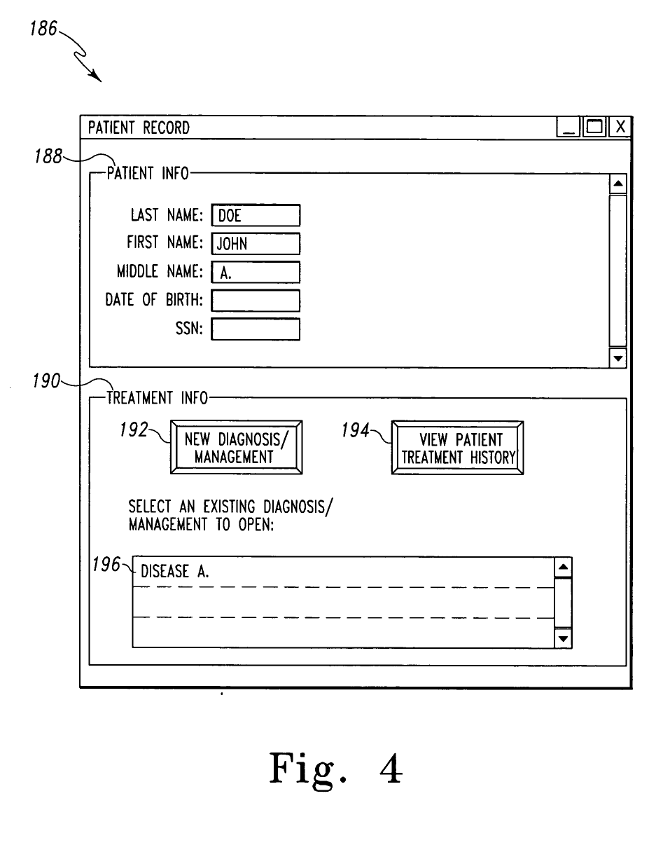

The stages outlined in FIGS. 2-3 will now be further illustrated by referring to FIGS. 4-7, which are simulated screens of one embodiment of system 20. This example illustrates how the user, such as a physician, can use the medical records system on medical records server 24 from a client computer (30a-30d) to automatically generate patient documentation and related activities. As shown in FIG. 4, screen 186 illustrates a selected patient record with patient information 188 and treatment information 190 (stage 104). Patient information such as name, date of birth, social security number, and so on can be displayed in patient information area 188. Treatment information 190 is also displayed to allow the user, such as the physician, to conduct a new diagnosis and/or management session, to resume a previous diagnosis and/or management session, or to view the patient treatment history (stage 106).

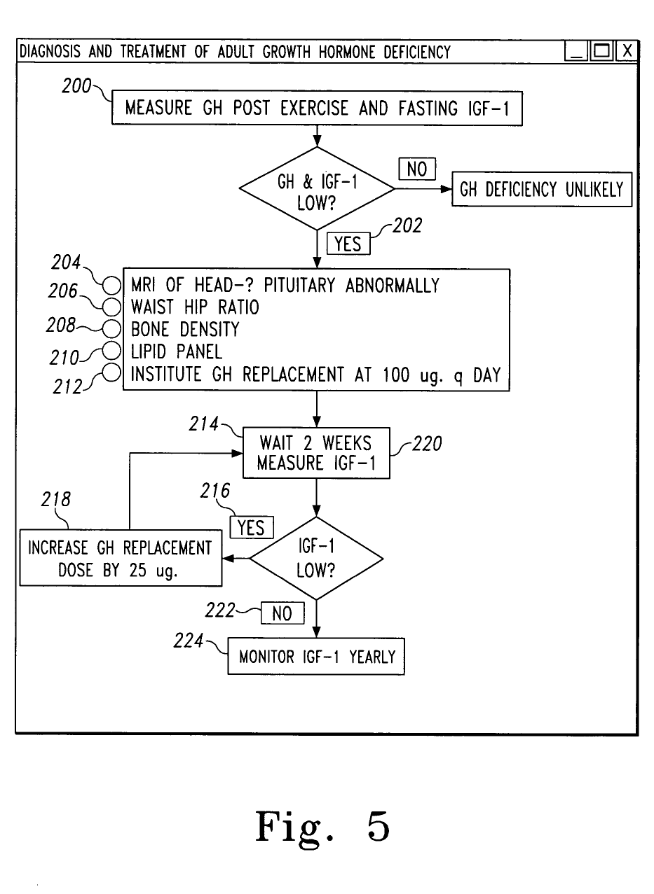

If the user selects the New Diagnosis/Management option 192 (stage 108), then the user is prompted to specify a particular disease or symptom(s) to diagnose and/or manage (stage 114). One of ordinary skill in the computer software art will appreciate that various types of selection methods can be used, such as selecting an item from one or more lists and/or typing in a portion or all of a desired phrase to locate a particular item, as a few non-limiting examples. Upon selection of a disease, a screen similar to FIG. 5 is displayed illustrating a flow chart corresponding to the selected disease that the user can navigate to assist with the diagnosis and/or management of the patient's problem (stage 116). The user navigates through the flow chart in one or more sessions by selecting decisions or options on the flow chart (stage 118). In one embodiment, the flow chart is an image that has a trigger associated with each of the various selectable positions in the image. When the user selects a particular position in the flow chart associated with the trigger, such as by moving an input device such as a mouse over a particular area and clicking, that trigger launches one or more scripts or actions. A few non-limiting examples of the scripts or actions that can be launched include those that automatically document the patient record, those that update one or more data elements in a database, and/or or those that launch other systems or activities. In this context a script is referring to one or more computer operations, and not to a medical prescription.

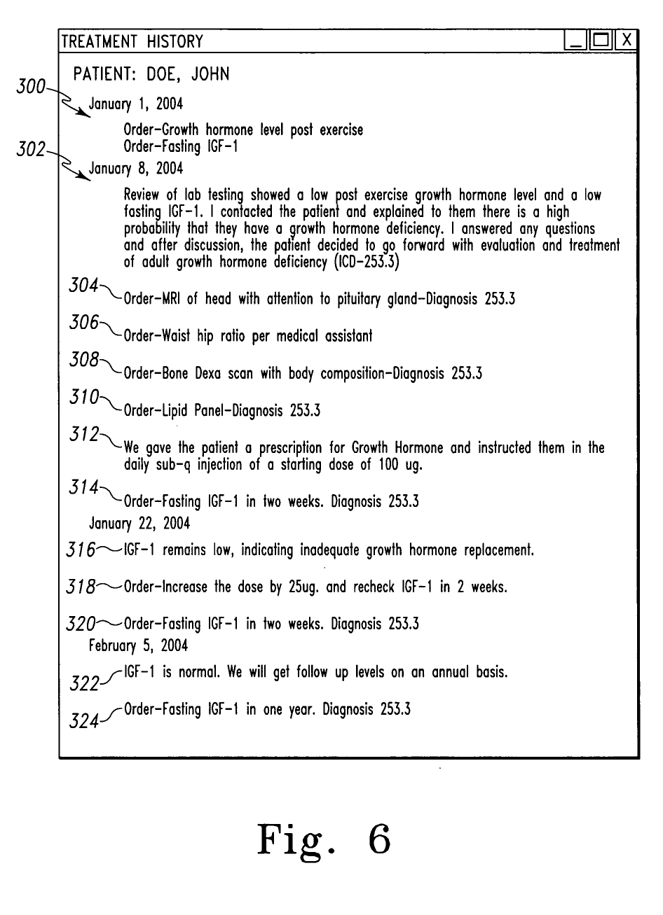

As one non-limiting example, suppose the user selects option 200, option 202, option 204, option 206, option 208, option 210, option 212, option 214, option 216, option 218, option 220, option 222, and option 224, in that order over multiple sessions. As each of those respective options is selected, documentation is generated in the patient record automatically that corresponds to the options selected (stage 120). An example of the documentation generated in the patient record can be viewed by selecting the View Patient Treatment History option 194 on FIG. 4. A screen similar to FIG. 6 is then displayed illustrating the patient documentation that was generated from the actions selected by the user on FIG. 5. For example, documentation 300 on FIG. 6 dated Jan. 1, 2004, was generated from selection of action 200 on FIG. 5. Documentation 302 was generated from selection of action 202 on FIG. 5. This corresponding pattern continues for each of the remaining documentation items.

Returning now to FIG. 5, other systems were also notified as appropriate based on the selection made by the user (stage 122). For example, upon selection of option 200, an order was placed for a growth hormone level post exercise and a separate order was placed for fasting IGF-1. These orders were sent to the appropriate system(s) for generation, such as Scheduling Server 26. Alternatively or additionally, these orders were generated from Medical Records Server 24.

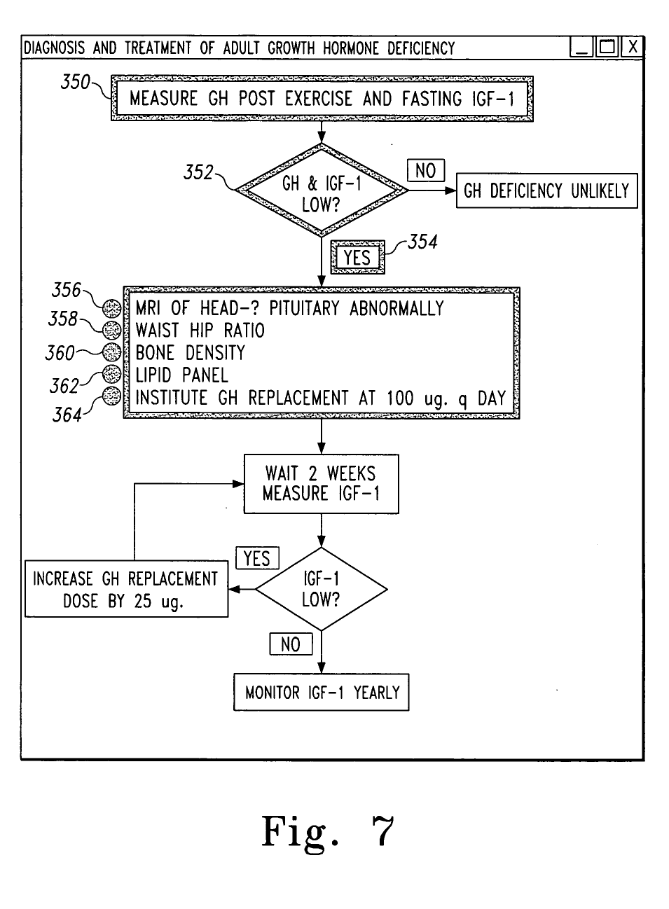

Returning now to FIG. 4, if the user selects an option 196 to open an existing diagnosis and/or management session, a screen similar to FIG. 7 is displayed. The path that was taken by the user in the one or more prior sessions is visually indicated on the screen, such as in a particular color and/or a particular shading, to name a few non-limiting examples. For example, option 350, option 352, option 354, option 356, option 358, option 360, option 362, and option 364 have previously been selected by the user, as visually indicated in FIG. 7.

In one embodiment, a system is disclosed that comprises a client computer; a server computer, said server computer being coupled to the client computer over a network; and wherein said server computer hosts a medical records program, said medical records program being operable to allow a user operating the client computer to access a patient record associated with a particular patient, to allow the user to make a series of selections to navigate through a flow chart to treat a condition of the particular patient, and to automatically document the patient record from the selections in the flow chart made by the user.

In another embodiment, an apparatus is disclosed that comprises a device encoded with logic executable by one or more processors to: provide a medical records program that is operable to: allow a user to access a patient record associated with a particular patient, to allow the user to make a series of selections to navigate through a flow chart to treat a condition of the particular patient, and to automatically document the patient record from the selections in the flow chart made by the user.

In yet a further embodiment, a method is disclosed that comprises retrieving a patient record associated with a particular patient; receiving input from a user to select a particular flow chart to be used by the user to assist with treating a condition of a patient; displaying the particular flow chart selected by the user; receiving a selection from the user of an action on the flow chart; and automatically recording documentation to the patient record based on the selection from the user.

One of ordinary skill in the computer software art will appreciate that the functionality, components and/or screens described herein can be separated or combined on one or more computers or screens in various arrangements and still be within the spirit of the invention.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

1. A system comprising:
a client computer;
a server computer, said server computer being coupled to the client computer over a network; and
wherein said server computer hosts a medical records program, said medical records program being operable to allow a user operating the client computer to access a patient record associated with a particular patient, to allow the user to make a series of selections to navigate through a flow chart to treat a condition of the particular patient, and to automatically document the patient record from the selections in the flow chart made by the user.

2. The system of claim 1, wherein the medical records program is operable to launch a scheduling system for scheduling a patient follow-up visit when the user selects a particular option in the flow chart that requires the patient follow-up visit.

3. The system of claim 1, wherein the medical records program is operable to assist with ordering a particular test when the user selects a particular option in the flow chart that requires the test.

4. The system of claim 1, wherein the medical records program is operable to assist with scheduling a task on a task list associated with a medical worker when the user selects a particular option that requires the task to be performed by the medical worker.

5. The system of claim 1, wherein the medical records program is operable to generate a referral document when the user selects a particular option that requires the referral document.

6. The system of claim 1, wherein the medical records program is operable to display a patient educational document generated from a template when the user selects a particular option that has educational material available.

7. The system of claim 1, wherein the medical records program is operable to display a separate data entry window when the user selects a particular option that requires additional data to be entered.

8. The system of claim 1, wherein the flow chart used by the medical records program is an image with a trigger associated with each of a plurality of positions in the image, and wherein each trigger launches one or more scripts to perform an associated action upon selection of the particular position in the flow chart associated with the trigger.

9. The system of claim 8, wherein the associated action is operable to update one or more values in a database.

10. The system of claim 8, wherein the associated action is operable to launch a separate program.

11. An apparatus comprising: a device encoded with logic executable by one or more processors to:
provide a medical records program that is operable to: allow a user to access a patient record associated with a particular patient, to allow the user to make a series of selections to navigate through a flow chart to treat a condition of the particular patient, and to automatically document the patient record from the selections in the flow chart made by the user.

12. The apparatus of claim 11, wherein the device includes a removable memory device carrying a number of processor executable instructions to define the logic.

13. The apparatus of claim 12, wherein the removable memory device includes a disk.

14. A method comprising:
retrieving a patient record associated with a particular patient;
receiving input from a user to select a particular flow chart to be used by the user to assist with treating a condition of a patient;
displaying the particular flow chart selected by the user;
receiving a selection from the user of an action on the flow chart; and
automatically recording documentation to the patient record based on the selection from the user.

15. The method of claim 14, further comprising:
repeating said receiving a selection and automatically documenting steps each time a user selects an action on the flow chart.

16. The method of claim 14, wherein the user is a physician.

17. The method of claim 14, wherein a scheduling system is launched for scheduling a patient follow-up visit when the selection from the user is received.

18. The method of claim 14, wherein a particular test is ordered when the selection from the user is received.

19. The method of claim 14, wherein a task is scheduled on a task list associated with a medical worker when the selection from the user is received.

20. The method of claim 14, wherein a referral document is generated when the selection from the user is received.

21. The method of claim 14, wherein a patient educational document is displayed when the selection from the user is received.

22. The method of claim 14, wherein a separate data entry window is displayed when the selection from the user is received.

23. The method of claim 14, wherein the particular flow chart has been previously opened by the user and wherein the one or more selections previously made in the flow chart by the user are visually indicated.

24. The method of claim 14, wherein the particular flow chart is an image with a trigger associated with each of a plurality of positions in the image, and wherein each trigger launches one or more scripts to perform an associated action upon selection of the particular position in the flow chart associated with the trigger.

25. The method of claim 24, wherein the associated action includes updating one or more values in a database.

26. The method of claim 24, wherein the associated action includes launching a separate program.
